(19) United States
(12) Patent Application Publication
(10) Pub. No.: US 2016/0064110 A1
(43) Pub. Date: Mar. 3, 2016

(54) PLASMONIC ACTIVATED GRAPHENE TERAHERTZ GENERATING DEVICES AND SYSTEMS

(71) Applicant: University of Maryland, College Park, MD (US)

(72) Inventors: Donald C. Schmadel, College Park, MD (US); Howard Dennis Drew, Hyattsville, MD (US)

(73) Assignee: University of Maryland, College Park, MD (US)

(21) Appl. No.: 14/843,468

(22) Filed: Sep. 2, 2015

Related U.S. Application Data
(60) Provisional application No. 62/044,782, filed on Sep. 2, 2014.

(51) Int. Cl. G21K 5/02

(52) U.S. Cl. CPC G21K 5/02

(57) ABSTRACT

Plasmonic activated graphene terahertz (THz) generating devices and generator systems are described based on the excitation of plasma resonances in a graphene element or structure by mixing two signals with a THz difference frequency. The excitation process is the photo-thermo-electric effect which has been demonstrated to be operative at THz frequencies in graphene. An antenna or other electrical component or device, such as an electrical or antenna lead, couples the THz radiation out of the sub-wavelength graphene element.

### PRIORITY

This application claims priority to a provisional application filed on Sep. 2, 2014 and assigned U.S. Application Ser. No. 62/044,782, the entire contents of which are incorporated herein by reference.

### TECHNICAL FIELD

The present disclosure relates to electromagnetic radiation sources, and more particularly, to terahertz generating devices and generator systems having a graphene element.

### BACKGROUND

Terahertz (THz) radiation has important uses in imaging, medical, security, spectroscopy, ranging, telecommunications, and other applications. Despite these and other uses for THz radiation, the THz spectral range is underdeveloped because of the lack of room temperature sources and detectors. Conventional terahertz generators are typically cooled to very low or cryogenic temperatures in order to operate effectively, which makes terahertz emitters expensive to operate.

### SUMMARY

The present disclosure is embodied in devices and systems for generating THz radiation based on the photo-thermo-electric effect in graphene. In particular, the present disclosure is embodied in devices and systems for generating THz radiation based on the photo-thermo-electric effect in graphene in which the devices can be operated at room temperature (e.g., 65-75 degrees Fahrenheit).

In accordance with an aspect of the present disclosure, a THz generating device is disclosed which includes a substrate, and a graphene element provided on the substrate. The THz generating device further includes an electrical or antenna lead coupled to the graphene element. During operation of the THz generating device, the electrical or antenna lead couples THz radiation out of the graphene element. The THz radiation occurs due to the generation of plasmons in the graphene element by the photo-thermo-electric effect caused by the use of heating source, such as, for example, at least one laser beam.

In embodiments, the substrate is silicon, such as a silicon wafer, and it is provided with an overcoat of silicon dioxide to form a silicon dioxide layer to act as the insulating layer and to aid in visualizing the graphene element.

In embodiments, the graphene element is placed onto the silicon dioxide layer by exfoliation.

In embodiments, the electrical or antenna lead is formed using E-beam lithography and PMMA photo resist in a lift-off method.

In accordance with another aspect of the present disclosure, a THz emitting or generator system is disclosed which includes a substrate, a graphene element provided on the substrate, an electrical or antenna lead coupled to the graphene element, and at least one heating or carrier excitation source for heating the graphene element during operation of the THz emitting system to generate THz radiation. The electrical or antenna lead couples the THz radiation out of the graphene element.

In embodiments, the substrate is silicon, such as a silicon wafer, and it is provided with an overcoat of silicon dioxide to form a silicon dioxide layer to act as the insulating layer and to aid in visualizing the graphene element.

In embodiments, the graphene element is placed onto the silicon dioxide layer by exfoliation.

In embodiments, the electrical or antenna lead is formed using E-beam lithography and PMMA photo resist in a lift-off method.

In embodiments, the at least one heating or carrier excitation source includes two laser sources each generating a laser beam. The two laser beams are incident interfering collinear laser beams having different optical frequencies directed as a spot onto the graphene element to heat the carriers in the graphene element and, through the thermo-electric effect, excite a plasma resonance whose frequency corresponds to their difference frequency.

In embodiments, the at least one heating or carrier excitation source includes two laser sources each generating a laser beam. The two laser beams are directed at two different locations on the graphene element generating two laser spots. The two laser spots are temporally out of phase by pi radians and heat the graphene element at different points. Thus, one side of the graphene element is heated while the other cools resulting in a dipole mode that can be coupled directly to a symmetric antenna.

These and other embodiments, as well as other aspects, in accordance with the present disclosure are described herein below. Several of the embodiments are described with reference to the various figures.

### BRIEF DESCRIPTION OF THE DRAWINGS

FIG. 1 illustrates a THz generating device having a graphene element in accordance with an embodiment of the present disclosure;

FIG. 2 illustrates a THz generating device having a graphene element in accordance with another embodiment of the present disclosure;

FIGS. 3a and 3b illustrate top and side views, respectively, of a THz generating device having a graphene element in accordance with another embodiment of the present disclosure;

FIGS. 4a and 4b illustrate top and side views, respectively, of a THz generating system and method of exciting plasmons in a graphene element using two laser beams separated by an angle α to generate THz radiation in accordance with the present disclosure;

FIG. 5 is a block diagram of a THz emitting or generator system for exciting plasmons in a graphene element to generate THz radiation in accordance with the present disclosure;

FIG. 6 is a top view of a THz generating device having a graphene element in accordance with still another embodiment of the present disclosure; and

FIGS. 7a and 7b illustrate enlarged top and side views, respectively, of the THz generating device shown by FIG. 6.

### DETAILED DESCRIPTION

In the Summary section above, in this Detailed Description, in the Claims below, and in the accompanying drawings, reference is made to particular features (including method steps or acts) of the present disclosure. It is to be understood that the disclosure in this specification includes combinations of parts, features, or aspects disclosed herein. For example, where a particular feature is disclosed in the context of a particular aspect or embodiment of the present disclosure, or a particular claim, that feature can also be used, to the extent possible, in combination with and/or in the context of other particular aspects and embodiments of the present disclosure, and in the disclosure generally.

The term “comprises” and grammatical equivalents thereof are used herein to mean that other components, ingredients, steps, acts, etc. are optionally present. For example, an article “comprising (or “which comprises”) component A, B, and C can consist of (i.e., contain only) components A, B, and C, or can contain not only components, A, B, and C but also one or more additional components, elements, features, ingredients, steps, acts, etc.

Where reference is made herein to a method comprising two or more defined steps or acts, the defined steps or acts can be carried out in any order or simultaneously (except where the context excludes that possibility); and the method can include one or more other steps or acts which are carried out before any of the defined steps or acts, between two of the defined steps or acts, or after all the defined steps or acts (except where the context excludes that possibility).

The term “at least” followed by a number is used herein to denote the start of a range beginning with that number (which may be a range having an upper limit or no upper limit, depending on the variable being defined). For example, “at least one” means one or more than one. When, in this specification, a range is given as “(a first number) to (a second number)” or “(a first number) (a second number),” this means a range whose lower limit is the first number and whose upper limit is the second number. For example, 25 to 100 mm means a range whose lower limit is 25 mm, and whose upper limit is 100 mm.

In the present disclosure, plasmonic activated graphene terahertz (THz) generating devices and systems are described based on the excitation of plasmons in a graphene element or structure by adding two signals with a THz difference frequency. The excitation process is the photo-thermo-electric effect, which has been demonstrated to be operative at THz frequencies in graphene.

In embodiments described herein, a conductive lead couples the THz radiation out of the sub-wavelength graphene element. The conductive lead may be an antenna that couples the THz radiation out of the graphene element and into the surrounding space. It is contemplated that in the embodiments described herein the antenna can be replaced by an electrical component, such as an electrical lead, for coupling the THz radiation out of the graphene element. The THz power may be thus directed to nearby circuitry.

The THZ emission is monochromatic with a bandwidth determine by that of the laser sources. The output power of the THz generating devices and systems described herein as a function of their generated frequency is estimated at 10's of μW's. The frequency falls within the 1 to 10 THZ range. In brief, the present disclosure is embodied in devices and systems for generating THz radiation based on the photo-thermo-electric effect in graphene.

The present disclosure makes use of the fact that graphene can be patterned into various shapes. A shape is also referred to herein as an element. The graphene shape or element used in the various embodiments of the present disclosure may be rectangular, square, or any other shape. When a laser pulse or continuous wave laser beam (non-pulsing) is directed at the graphene element, carriers are excited to higher energy levels. Electron/electron scattering will distribute this energy among other nearby carriers on a time scale of ˜10 femto seconds or less. The result is a charge wave or plasmon.

For a rectangular graphene element having a length on the order of a micron, the carrier density can be adjusted to result in a plasmon frequency of ˜3 THz, which corresponds to a carrier concentration of ˜10¹² electrons per square centimeter. This carrier concentration can be obtained by using a gate electrode separated from the graphene by a 300 nm thick layer of silicon dioxide. For a graphene element originally at the charge neutral point, a gate voltage of approximately 40 V will result in approximately 10¹² carriers per square centimeter.

The plasmon will decrease in amplitude due to various losses, for example, carrier scattering by defects and phonons in the graphene lattice or substrate. For suspended graphene with a mobility of 100,000 cm²/(V sec), the plasmon lifetime can be longer than a picosecond. For a 3 THz plasmon, this corresponds to a Q>10 and a plasmon with a bandwidth on the order of 10% of the center frequency.

In free space, 3 THz radiation has a wavelength equal to ˜100 microns, much larger than the plasmon wavelength of ˜2 microns. Consequently, the plasmon will not radiate significantly into free space. However, radiation into free space can be enhanced by the placement of an antenna as described herein so as to more closely couple the plasmon field to a free space propagating wave.

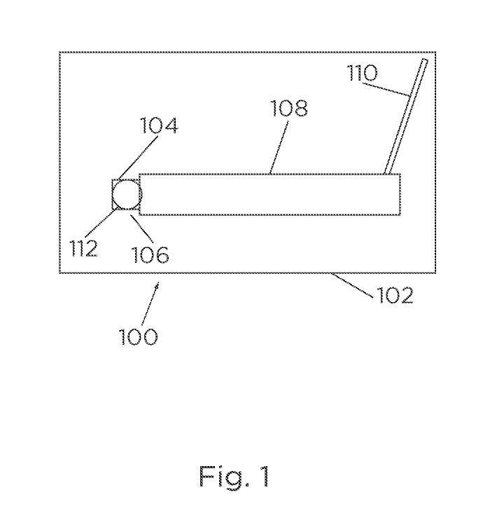

FIG. 1 illustrates a THz generating device in accordance with an embodiment of the present disclosure. The device is designated generally by reference numeral 100 and it includes a substrate 102. The substrate 102 can be, for example, a 300 micron thickness of silicon of any size, such as, for example, a silicon wafer of any size. A graphene element 104 is placed on the substrate 102.

If the substrate 102 is silicon, it may be provided with an overcoat of silicon dioxide (e.g., 300 nm of silicon dioxide) to act as an insulating layer 106. The graphene element 104 is then placed on the insulating layer 106. The insulating layer 106 aids in visualizing the graphene element 104. The graphene element 104 may be placed onto the silicon dioxide layer by exfoliation. The embodiments described herein with respect to the other figures may also be provided with an insulating layer, e.g., an overcoat of silicon dioxide (e.g., 300 nm silicon dioxide) if their substrate is silicon. The silicon substrate 102 of the various embodiments can have a resistivity of 100 Ohm cm.

As shown by FIG. 1, an electrical lead 108 is provided on the substrate 102 and in contact with the graphene element 104. The electrical lead 108 may be used to convey the THz power to other nearby electrical elements. The electrical lead 108 may be formed using standard E-beam lithography and PMMA photo resist in a lift-off method.

In an embodiment, the electrical lead 108 is on the order of 2 microns wide and 10 microns long and consists of a 5 nm chrome adhesion layer and a 70 nm layer of gold evaporated onto the substrate 102.

In embodiments described herein, the graphene element is on the order of a micron square. If the substrate is silicon, the graphene element may be gated by applying a voltage between the silicon substrate and electrical lead, such as electrical lead 108, by means of a trace or gating lead 110 as shown by FIG. 1. The trace or gating lead 110 is formed narrow as shown so as to introduce more impedance, which reduces its effect upon the terahertz wave of the copper lead 108. Typical gate voltages range from 0 to 80 Volts, which can develop carrier concentrations to around 7×10¹² or more. The carrier density can be adjusted by the gate voltage to maximize the useful output of the device 100.

In the embodiment shown by FIG. 1, a pulse of a focused laser beam generated by a laser source (not shown) serves as a carrier excitation source to excite the carriers within the graphene element 104. The beam may be focused near the center of the graphene element 104. The beam locally heats the carriers within a spot 112 causing them to move toward the edges of the graphene element 104 resulting in plasmons. This in turn excites a THz electromagnetic wave in the electrical lead 108 which radiates THz radiation into free space or is directed to other electronic or electric circuitry. It is contemplated that electrical lead 108 is an antenna lead.

The laser pulse can have temporal features, e.g. a short pulse width, on the order of the frequency of the THZ radiation desired to be generated. For example, for 2 THZ radiation such a laser pulse should have a duration less than ˜250 femto-seconds and could be supplied by a pulsed laser, such as a C-Fiber 1560 manufactured by Menlo Systems GmbH located in Martinsried, Germany.

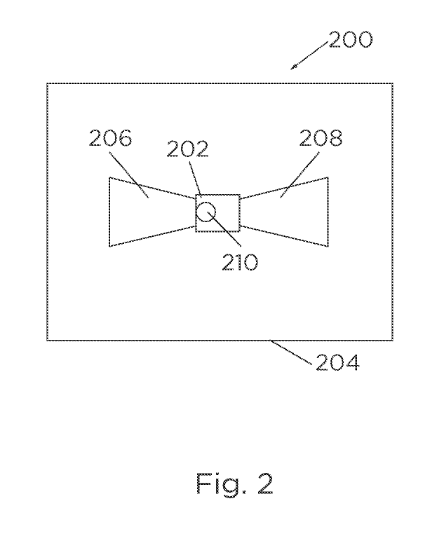

FIG. 2 illustrates another embodiment of a THz generating device designated generally by reference numeral 200. The THz generating device 200 has a graphene element 202 on a substrate 204. The graphene element 202 is connected to two conducting elements 206 and 208. In this embodiment, pulsed laser beam (i.e., carrier excitation source) is shifted to the left in order for illumination spot 210 to be off-center.

The embodiment of FIG. 2 causes the graphene element 202 to generate a plasmon that is asymmetric across the graphene element 202. As a result, the electric field near one electrical or antenna lead 206 is out of phase with that at the other electrical or antenna lead 208 as required for the device 200 to radiate as a dipole mode into free space. Antenna leads 206, 208 can be leads of a bowtie antenna for radiating the THz radiation into free space.

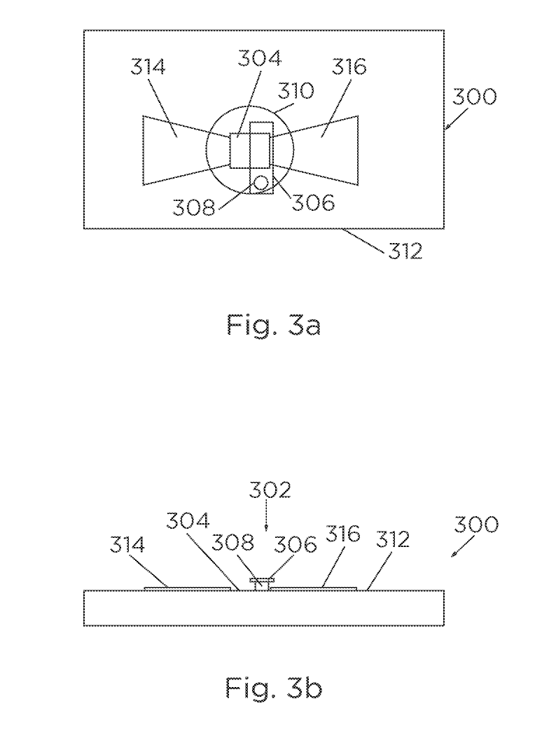

FIGS. 3a and 3b illustrate an alternative embodiment of a THz generating device according to the present disclosure and designated generally by reference numeral 300. In this embodiment, a pulsed laser beam 302 (represented by the vertical arrow shown by FIG. 3b) (i.e., carrier excitation source) is a planar wavefront incident upon graphene element 304, a portion of which is shaded by, for example, a metal strip 306 held in place by a column 308. This results in asymmetric illumination of the graphene element 304 without requiring the laser beam 302 to be shifted and focused to a particular side of the graphene element 304 in order to have the illumination spot 310 off-center as in the embodiment shown by FIG. 2. Reference numeral 312 identifies the substrate, which may be silicon or the like as in the embodiment described above with reference to the embodiment shown by FIG. 1.

Reference numerals 314, 316 identify the electrical or antenna leads which function in the same manner as described above for electrical or antenna leads 206, 208 of the embodiment shown by FIG. 2. Reference numeral 312 identifies the substrate, which can be silicon or the like as described above with reference to the embodiment shown by FIG. 1.

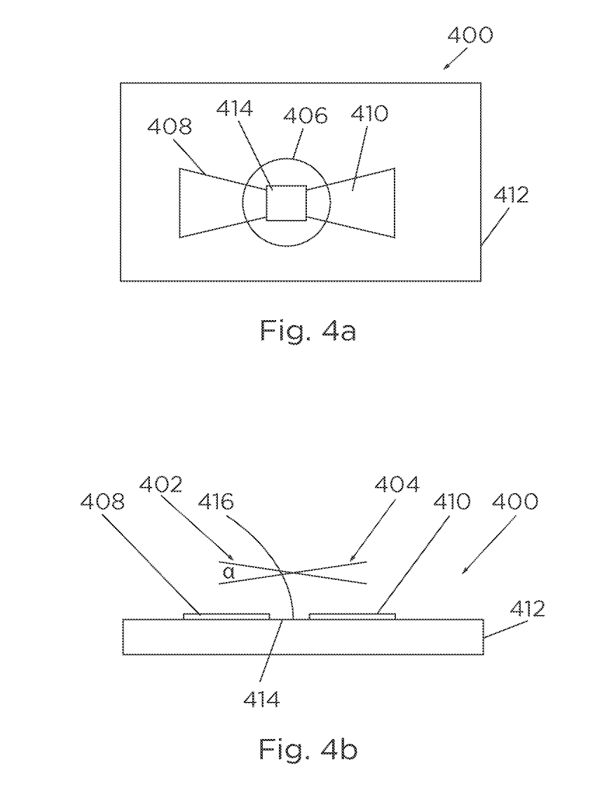

FIGS. 4a and 4b illustrate an alternative embodiment of a THz generating device designated generally by reference numeral 400. In the embodiment shown by FIGS. 4a and 4b, two carrier excitation sources or laser sources (not shown) are used to generate two laser beams whose wavefronts are designated by reference numerals 402 and 404, which are separated at an angle α as shown. The beams are incident on the graphene element 414.

The polarization of the two beams is chosen to be parallel resulting in an illumination pattern 406 (see FIG. 4a) with lines of maxima and minima power across graphene element 414. The maxima are spaced from left to right at intervals approximately equal to the average of the wavelengths of the two laser beams 402, 404 times 1/(2 sin α/2). This pattern of minima and maxima lines shifts to the right if the wavelength of incident wavefront 404a is smaller than that of incident wavefront 402a, or shifts to the left if incident wavefront 402a is smaller than that of incident wavefront 404a.

If the wavelengths of the two laser beams 402, 404 are chosen so that the maxima lines are separated by a distance near to that of the plasmon wavelength and if the difference frequency corresponds to a plasmon frequency then the plasmon will be excited. The embodiment shown by FIGS. 4a and 4b does not require accurate or precise aiming of a focused laser spot near the area identified by reference numeral 416 of the graphene element 414.

Reference numerals 408, 410 identify the electrical or antenna leads which function in the same manner as described above for electrical or antenna leads 206, 208 of the embodiment shown by FIG. 2. Reference numeral 412 identifies the substrate, which can be silicon or the like as described above with reference to the embodiment shown by FIG. 1.

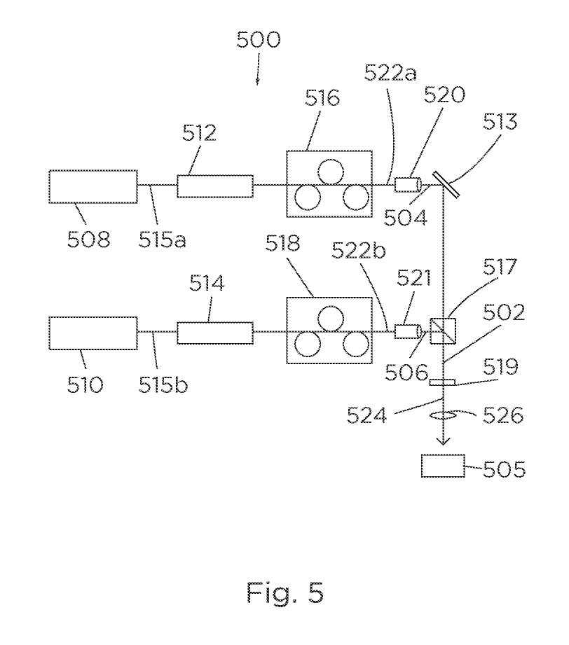

FIG. 5 illustrates an example of a THz emitting or generator system in accordance with the present disclosure which uses continuous wave or CW lasers to excite carriers in the graphene element as an alternative to using a pulse laser system to excite the carriers in the graphene element. The THz emitting or generator system is designated generally by reference numeral 500 and it is arranged to direct a laser beam 502 containing two different continuous wave (CW) optical frequencies upon a graphene element 505. The graphene element 504 can be part of an embodiment described herein with respect to the various figures such as graphene element 104 shown in FIG. 1.

The resulting illumination power focused on the graphene element 504 by the laser beam 502 varies sinusoidally in time corresponding to a difference frequency of the two laser beams 504, 506. It is contemplated that the difference frequency can be set to correspond to that of a plasmon in the graphene element 505 which is excited as a result of the laser beam 502. In the THz emitting or generator system 500 shown by FIG. 5, the graphene element 505 acts as a mixer, generating a plasmon frequency corresponding to the difference frequency.

With continued reference to FIG. 5, light from laser source 508, which may be, for example, an Agilent model 81689A or its equivalent available from Keysight Technologies of Santa Rosa, Calif., and light from laser source 510, which may be, for example, a Photonetics Tunics BT Wavelength Tunable Laser or its equivalent available from GN Nettest of Brondby, Denmark, are each increased in power by amplifiers 512, 514, which may be, for example, Erbium Fiber Amplifiers available from IPG Photonics Corporation of Novi, Mich. Optical fibers 515a, 515b propagate the laser beams 504, 506 from the laser sources 508, 510 to the amplifiers 512, 514.

Polarization controllers 516, 518, which may be, for example, FPC032 available from Thorlabs, Inc. of Newton, N.J., adjust the polarization of each laser beam 504, 506 separately so that the laser beam 504 generated by laser source 508 passes through polarizing beamsplitter 517 and light originally from laser source 510 is reflected by the polarizing beamsplitter 517. Lenses 520, 521, which may be, for example, F280APC-1550 available from Thorlabs, Inc., collimate the laser beams 504, 506 emerging from each of the optical fibers 522a, 522b. Mirror 513 is located and positioned so that each laser beam emerges from beamsplitter 517 essentially collinear.

Polarizer 519 which may be, for example, polarizing beam splitter PBS254 available from Thorlabs, Inc., is set at about a 45 degree angle to the polarization of the two laser beams 504, 506 allowing an equal portion of each to pass with the same polarization. The resulting beams interfere producing an essentially fully amplitude modulated laser beam 524 having a modulation frequency equal to the difference in the optical frequencies of each. Lens 526 may be used to focus the laser beam 524 onto the graphene element 505.

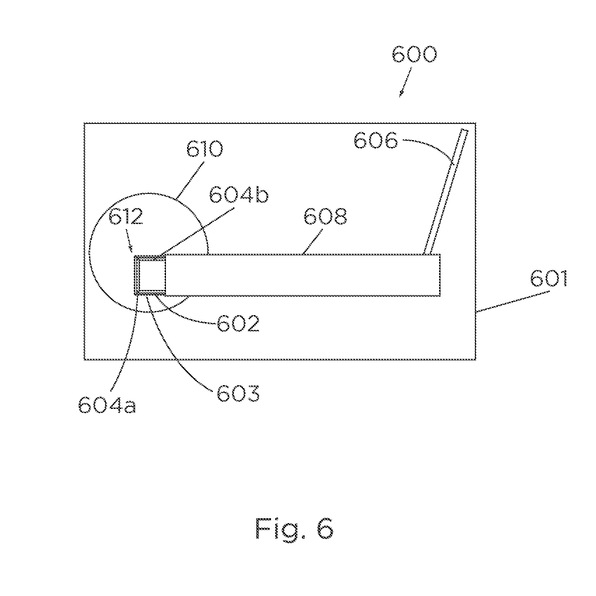

FIG. 6 is a top view of a THz generating device designated generally by reference numeral 600 in accordance with still another embodiment of the present disclosure. The THz emitting device 600 includes a substrate 601. The substrate 601 can be the same substrate as the substrate 102 described above for at least the THz generating device 100 shown by FIG. 1.

As with the embodiments described above, an insulating layer 603 may be placed or positioned on top of the substrate 601. If the substrate 601 is silicon, it may be provided with an overcoat of silicon dioxide (e.g., 300 nm of silicon dioxide) to act as the insulating layer 603 as with the embodiment described above with reference to FIG. 1. A graphene element 602 is positioned between two boron nitride layers 604a, 604b forming a graphene-boron nitride structure 612. Boron nitride layer 604a is positioned on the insulating layer 603, if an insulating layer is provided.

Reference numeral 606 identifies an optional electrical trace or gating lead as described above with respect to at least the embodiment shown by FIG. 1. Reference numeral 608 identifies an electrical or antenna lead coupled to the graphene-boron nitride structure 612 for radiating the THz radiation or power generated by the graphene element 602 as described above with respect to at least the embodiment shown by FIG. 1. Reference numeral 610 identifies an illumination spot generated by a laser beam, as described above with the other embodiments of the present disclosure, and encircling the graphene-boron nitride structure 612.

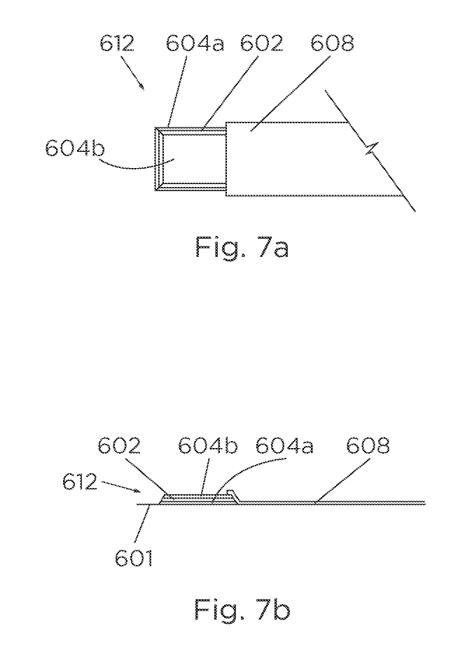

FIGS. 7a and 7b illustrate enlarged top and side views, respectively, of the THz emitting device 600 shown by FIG. 6. The carriers in the graphene element 602 can be excited by directing a laser beam onto the graphene-boron nitride structure 612. The laser beam can be a continuous wave or pulsed laser beam generated by a heating or carrier excitation source, such as a laser source.

The THz emitting device 600 results in graphene with very high mobilities (e.g., >40,000 cm²/Vs with 4×10¹² carriers per square centimeter). Therefore, the emitting device 600 shown by FIGS. 6, 7a and 7b results in a higher output power.

Although the present disclosure has been described in considerable detail with reference to certain preferred version thereof, other versions are possible and contemplated. Therefore, the spirit and scope of the appended claims should not be limited to the description of the preferred versions contained therein.

Any element in a claim that does not explicitly state “means for” performing a specified function or “step for” performing a specified function, is not to be interpreted as a “means” or “step” clause as specified in 35 U.S.C. §112(f). In particular, the use of “step of” in the claims is not intended to invoke the provisions of 35 U.S.C. §112(f).

What is claimed is:

1. A THz emitting device comprising:
a substrate;
a graphene element positioned on the substrate; and
at least one electrical or antenna lead positioned on the substrate and coupled to the graphene element.

2. The THz generating device according to claim 1, wherein the substrate is a silicon substrate.

3. The THz generating device according to claim 1, wherein the substrate is provided with an overcoat of silicon dioxide to form a silicon dioxide layer to act as an insulating layer between the substrate and the graphene element.

4. The THz generating device according to claim 1, further comprising an electrical trace coupled to the at least one electrical or antenna lead.

5. The THz generating device according to claim 1, wherein the graphene element is rectangular.

6. The THz generating device according to claim 1, further comprising a blocking member positioned over at least a portion of the graphene element.

7. The THz generating device according to claim 6, wherein the blocking member is a metal strip.

8. The THz generating device according to claim 1, further comprising two boron nitride layers sandwiching the graphene element and forming a graphene-boron nitride structure.

9. A THz generator system comprising:
at least one heating or carrier excitation source; and
a THz generating device comprising:
a substrate;
a graphene element positioned on the substrate; and
at least one electrical or antenna lead positioned on the substrate and coupled to the graphene element.

10. The THz generator system according to claim 9, wherein the substrate is a silicon substrate.

11. The THz generator system according to claim 9, wherein the substrate is provided with an overcoat of silicon dioxide to form a silicon dioxide layer to act as an insulating layer between the substrate and the graphene element.

12. The THz generator system according to claim 9, further comprising an electrical trace coupled to the at least one electrical or antenna lead.

13. The THz generator system according to claim 9, wherein the graphene element is rectangular.

14. The THz generator system according to claim 9, further comprising a blocking member positioned over at least a portion of the graphene element.

15. The THz generator system according to claim 14, wherein the blocking member is a metal strip.

16. The THz generator system according to claim 9, further comprising two boron nitride layers sandwiching the graphene element and forming a graphene-boron nitride structure.

17. The THz generator system according to claim 11, wherein the graphene element is placed onto the silicon dioxide layer by exfoliation.

18. The THz generator system according to claim 9, wherein the at least one heating or carrier excitation source includes two laser sources.

19. The THz generator system according to claim 18, wherein two laser beams generated by the two laser sources are incident interfering collinear laser beams having different optical frequencies directed as a spot onto the graphene element to heat the carriers in the graphene element.

20. The THz generator system according to claim 19, wherein the at least one heating or carrier excitation source includes two laser sources each generating a laser beam, wherein the two laser beams are directed at two different locations on the graphene element generating two laser spots, and wherein the two laser spots are temporally out of phase by pi radians.

21. A method of generating THz radiation comprising:
providing a heating source; and
heating a graphene element positioned on a substrate using the heating source to heat carriers in the graphene element.
